(19) United States
(12) Patent Application Publication
(10) Pub. No.: US 2013/0010593 A1
(43) Pub. Date: Jan. 10, 2013

(54) METHOD FOR MANAGING LOAD, METHOD FOR SYSTEM ACCESS, BASE STATION AND TERMINAL IN MOBILE COMMUNICATION SYSTEM

(75) Inventors: Jae Sun CHA, Daejeon (KR); Soojung Jung, Daejeon (KR); Seokki Kim, Osan-si (KR); Chul Sik Yoon, Seoul (KR); Kwang Jae Lim, Daejeon (KR)

(73) Assignee: ELECTRONICS AND TELECOMMUNICATIONS RESEARCH INSTITUTE, Daejeon (KR)

(21) Appl. No.: 13/544,375

(22) Filed: Jul. 9, 2012

(30) Foreign Application Priority Data
Jul. 8, 2011 (KR) 10-2011-0068079
Jul. 6, 2012 (KR) 10-2012-0073902

(51) Int. Cl. H04W 74/08; H04W 28/02

(52) U.S. Cl. 370/230; 370/329

(57) ABSTRACT

A system access method of a terminal in a mobile communication system according to an exemplary embodiment of the present invention includes receiving a control channel or a control message including resource allocation information, an access restriction indicator, and information about a random access region from a base station, and determining whether or not to access the base station according to a set value of the access restriction indicator.

### CROSS-REFERENCE TO RELATED APPLICATION

This application claims priority to and the benefit of Korean Patent Application Nos. 10-2011-0068079 and 10-2012-0073902 filed in the Korean Intellectual Property Office on Jul. 8, 2011 and Jul. 6, 2012, the entire contents of which are incorporated herein by reference.

### BACKGROUND OF THE INVENTION

(a) Field of the Invention

The present invention relates to a mobile communication system. Specifically, the invention relates to a system access method of a terminal and a load management method of a base station in a mobile communication system.

(b) Description of the Related Art

In a mobile communication system, a base station can support a limited number of terminals. When a large number of terminals simultaneously access the base station, overload is generated in the base station. Accordingly, the base station controls the load thereof by blocking access of a new terminal to maintain communication service for terminals connected to the base station.

To achieve this, the base station periodically broadcasts system information and a terminal performs an access procedure using the system information received from the base station.

Here, since a system information transmission interval is several hundred milliseconds to several seconds, load control of the base station cannot be rapidly performed. Furthermore, when heterogeneous terminals (e.g. M2M terminals defined in IEEE 802.16p and non-M2M terminals defined in IEEE 802.16m) coexist, base station load control for one type of terminal may affect the other type of terminal.

### SUMMARY OF THE INVENTION

An exemplary embodiment of the present invention provides a system access method of a terminal and a load management method of a base station in a mobile communication system.

In accordance with an exemplary embodiment of the present invention, in a system access method of a terminal in a mobile communication system, the method includes receiving a control channel or a control message including resource allocation information, an access restriction indicator, and information about a random access region from a base station, and determining whether or not to access the base station according to a set value of the access restriction indicator.

In accordance with another exemplary embodiment of the present invention, a method for managing load at a base station in a mobile communication system includes setting an access restriction indicator according to base station load, and transmitting a control channel or a control message including resource allocation information, the access restriction indicator, and information about a random access region to a terminal.

In accordance with another exemplary embodiment of the present invention, a terminal includes a radio frequency (RF) unit; and a processor, wherein the processor is configured to receive a control channel or a control message including resource allocation information, an access restriction indicator and information about a random access region from a base station and to determine whether or not to access the base station according to a set value of the access restriction indicator.

In accordance with another exemplary embodiment of the present invention, a base station includes an RF unit and a processor, wherein the processor is configured to set an access restriction indicator according to base station load and to transmit a control channel or a control message including the access restriction indicator and information about a random access region.

### BRIEF DESCRIPTION OF THE DRAWINGS

FIG. 1 is a flowchart illustrating a load management method of a base station in a mobile communication system;

FIG. 2 illustrates an exemplary frame structure for transmitting system information;

FIG. 3 illustrates an exemplary random access procedure of a terminal;

FIG. 4 is a flowchart illustrating a load management method of a base station according to an exemplary embodiment of the present invention;

FIG. 5 illustrates a frame structure for load management according to an exemplary embodiment of the present invention;

FIG. 6 is a flowchart illustrating a load management method of a base station according to another exemplary embodiment of the present invention;

FIG. 7 illustrates a frame structure for load management according to another exemplary embodiment of the present invention; and

FIG. 8 illustrates a terminal and a base station applicable to exemplary embodiments of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

In the specification, a mobile station (MS) may refer to a terminal, a mobile terminal (MT), a subscriber station (SS), a portable subscriber station (PSS), an access terminal (AT), user equipment (UE), etc., and may include all or some functions of the terminal, MT, SS, PSS, AT, UE, etc.

A base station (BS) may refer to a nodeB, an evolved nodeB (eNodeB), an access point (AP), a radio access station (RAS), a base transceiver station (BTS), a mobile multihop relay (MMR)-BS, etc., and may include all or some functions of the nodeB, eNodeB, AP, RAS, BTS, MMR-BS, etc.

Exemplary embodiments of the present invention can be applied to a mobile communication system in which heterogeneous terminals (e.g. M2M terminals defined in IEEE 802.16p and non-M2M terminals defined in IEEE 802.16m) coexist as well as normal mobile communication systems. The M2M terminal means a terminal used for M2M (machine to machine) communication without intervention of people.

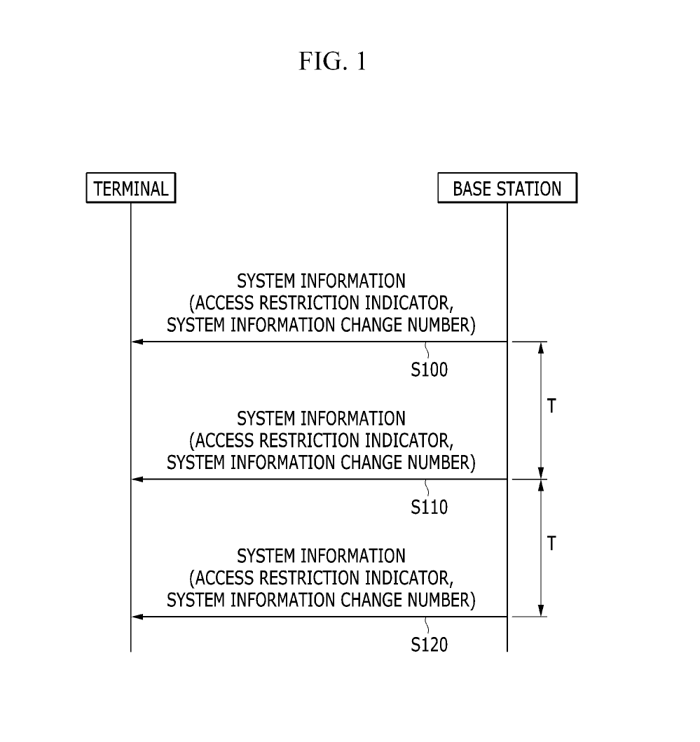

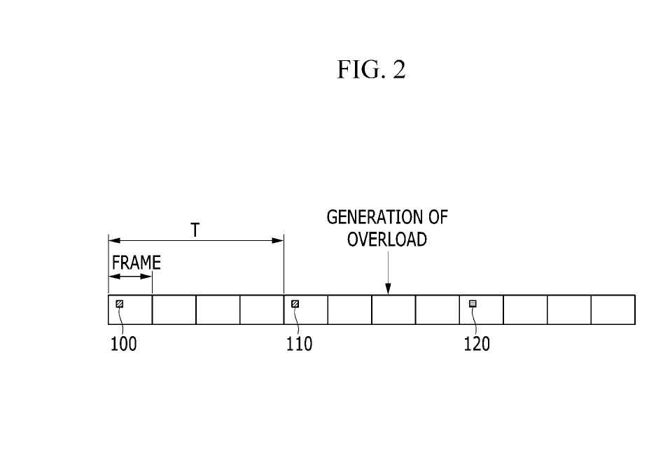

FIG. 1 is a flowchart illustrating a load management method of a base station in a mobile communication system, and FIG. 2 illustrates an exemplary frame structure for transmitting system information.

Referring to FIG. 1, the base station broadcasts system information at predetermined intervals T (S100, S110, and S120). Accordingly, a terminal can acquire system information necessary for system access. First control information that all terminals receive from the base station before accessing the base station is the system information.

The system information broadcast by the base station includes access restriction indicators 100, 110, and 120 with respect to the base station. The access restriction indicators may be set to a value indicating that access to the base station is permitted or a value indicating that access to the base station is not permitted. The base station normally transmits the access restriction indicators 100 and 110 set to the value indicating that access to the base station is permitted. However, when overload is generated in the base station, the base station transmits the access restriction indicator 120 set to the value indicating that access to the base station is not permitted.

The terminal may check the access restriction indicator included in the system information and perform an access procedure for the base station only when the access restriction indicator is set to the value indicating that access to the base station is permitted.

The terminal needs to know the system information for continuous access as well as for initial access to the base station. Accordingly, if the system information is changed, the terminal needs to know the changed system information. For this, the system information may further include an indicator indicating system information change (e.g. system information change number). When the terminal receives system information, the terminal can compare a system information change number included in previously received system information with a system information change number included in the newly received system information. When the two system information change numbers are different from each other, the terminal can perform system access using the newly received system information.

Here, the base station cannot be aware of whether all terminals have successfully received changed system information. Accordingly, the base station may repeatedly transmit the changed system information more than several times, and then apply the changed system information.

In general, the system information transmission interval T may be set to several hundred milliseconds to several seconds in order to reduce downlink resource overhead. Accordingly, if overload is generated right after the base station transmits the system information, the base station can transmit the access restriction indicator set to the value indicating that access to the base station is not permitted at the next system information transmission time. Even when the overload is cancelled, the base station can transmit the access restriction indicator set to the value indicating that access to the base station is permitted at the next system information transmission time. That is, load control of the base station cannot be rapidly performed.

Furthermore, the terminal needs to update system information whenever the system information change number is changed. When a base station controls heterogeneous terminals (e.g. M2M terminals defined in IEEE 802.16p and non-M2M terminals defined in IEEE 802.16m), if system information for one type of terminals is changed, system information for the other type of terminals must be updated. For example, the number of M2M terminals is greater than the number of non-M2M terminals. When a large number of M2M terminals simultaneously access the base station to cause generation of overload in the base station and the base station transmits changed system information, the non-M2M terminals should update system information corresponding thereto although the system information is not changed and the non-M2M terminals cannot access the base station.

Particularly, overload generated due to the M2M terminal lasts for a short time compared to overload caused by the non-M2M terminal. Accordingly, a base station load control method optimized for the M2M terminal is needed.

An exemplary embodiment of the present invention controls load of the base station using a control channel or a control message that designates a random access region of a terminal. A description will be given of a method for controlling load of the base station according to an exemplary embodiment of the present invention.

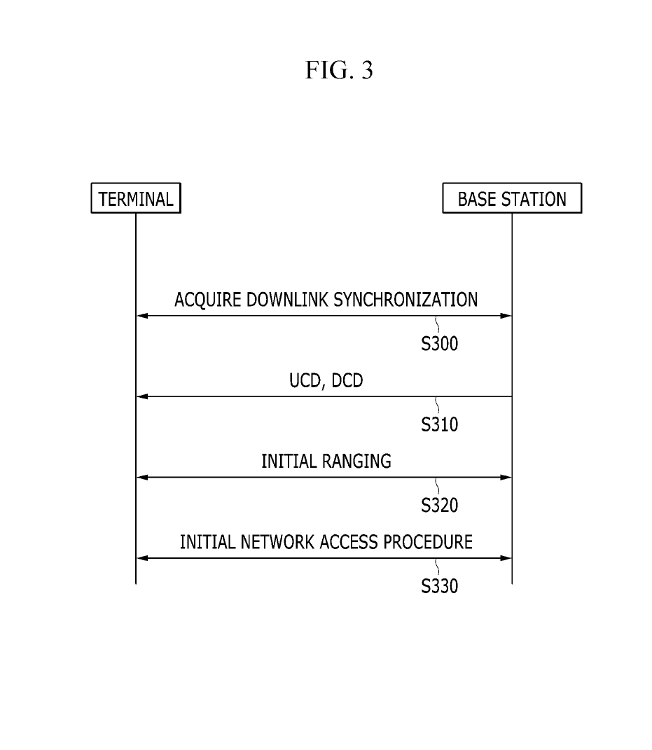

FIG. 3 illustrates an exemplary random access procedure of a terminal. While FIG. 3 illustrates a random access (ranging) procedure in IEEE 802.16, the present invention is not limited thereto.

Referring to FIG. 3, the terminal acquires downlink synchronization with the base station (S300), and then receives system information transmitted from the base station (S310). The system information can be transmitted through a DCD (downlink channel descriptor) or UCD (uplink channel descriptor), for example. The DCD includes system information necessary for downlink access. The UCD includes system information necessary for uplink access.

Upon reception of the system information through the DCD and UCD, the terminal attempts to perform initial ranging for acquisition of uplink synchronization with the base station (S320). If the terminal successfully performs initial ranging, the terminal acquires both downlink synchronization and uplink synchronization with the base station.

Subsequently, the terminal performs an initial network access procedure for the base station (S330).

To perform initial ranging, the terminal needs to know information about a ranging region (i.e. random access region). The information about the ranging region may be included in the UCD. For example, the UCD can include the size, position, and allocation interval of a region where initial ranging can be performed. Accordingly, the terminal can be aware of the information about the ranging region upon receiving the UCD from the base station. The information about the ranging region may be included in a control channel or a control message which includes resource allocation information. For example, a MAP, which is transmitted on a frame by frame basis in IEEE 802.16e, can include the information about the ranging region.

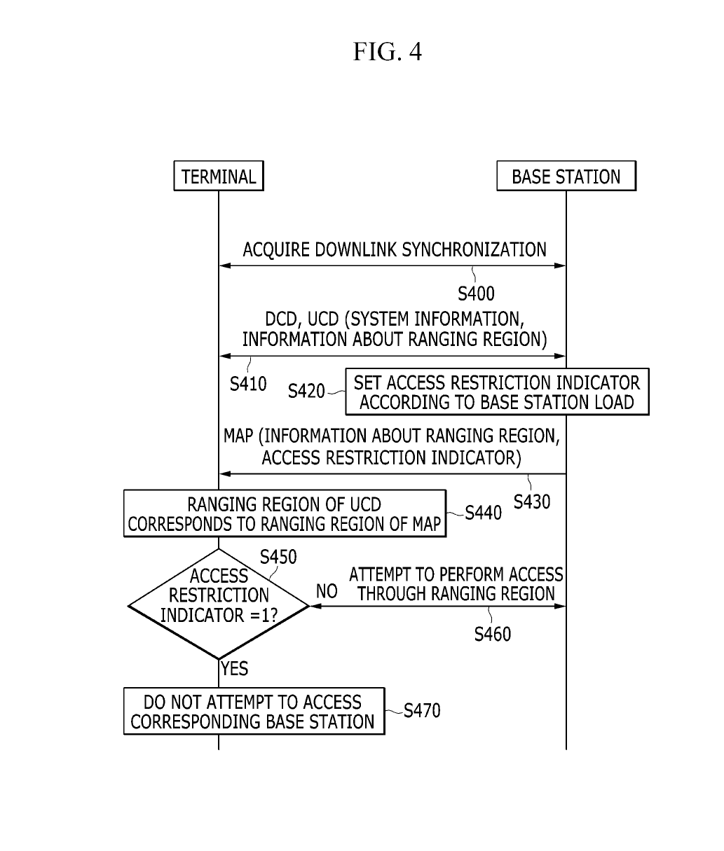

FIG. 4 is a flowchart illustrating a load management method of a base station according to an exemplary embodiment of the present invention.

Referring to FIG. 4, a terminal acquires downlink synchronization with the base station (S400) and then receives system information broadcast by the base station (S410). The system information can be transmitted through the DCD or UCD. The DCD may include system information necessary for downlink access and the UCD may include system information necessary for uplink access. The UCD may further include information about a ranging region. The ranging region means a resource region in which initial ranging can be performed and may be used as a random access region.

The base station sets an access restriction indicator according to base station load (S420). For example, when the base station load exceeds a predetermined reference value, the base station can set the access restriction indicator to a value (e.g. 1) indicating that access of the terminal is not permitted.

The base station transmits MAP including the access restriction indicator and information about a ranging region to the terminal (S430). Steps S420 and S430 may be performed on a frame by frame basis. Steps S420 and S430 may be performed whenever the load state of the base station is changed. The MAP represents a control channel or control message that includes resource allocation information.

The terminal compares the information about the ranging region, included in the MAP, with the information about the ranging region allocated through the UCD (S440).

Table 1 shows exemplary information about the ranging region allocated through the UCD, and Table 2 shows exemplary information about the ranging region included in the MAP.

TABLE 1

| | Type | | |
|---|---|---|---|
| Name | (1 byte) | Length | Value |
| Rang- | 25 | 6 | Bit 0: dedicated ranging indicator |
| ing | | | Bits 1-2: ranging method |
| Re- | | | Bits 3-9: number of subchannels |
| gion | | | Bits 10-16: number of OFDMA symbols |
| | | | Bits 17-23: subchannel offset |
| | | | Bits 24-31: OFDMA symbol offset |
| | | | Bits 32-34: parameter d that defines |
| | | | periodicity of 2^{d} frames |
| | | | Bits 35-39: allocation phase expressed in |
| | | | frames. |
| | | | 0 ≦ Allocation Phase < periodicity(=2^{d}) |
| | | | Bits 41-47: reserved |

TABLE 2

| | | |
|---|---|---|
| | Size | |
| Syntax | (bit) | Notes |

Ranging allocation
UL-MAP {

| Extended UIUC | 4 | Ranging allocation UL-MAP |
|---|---|---|
| | | extended = 0xB |
| Length | 4 | |
| OFDMA symbol offset | 8 | |
| Number of OFDMA | 7 | |
| symbols (No. OFDMA | | |
| Symbols) | | |
| Number of subchannels | 7 | |
| (No. Subchannels) | | |
| Ranging method | 2 | 0b00: Initial/Handover ranging |
| | | over two symbols |
| | | 0b01: Initial/Handover ranging |
| | | over four symbols |
| | | 0b10-0b11: reserved |
| Dedicated ranging | 1 | 0: The OFDMA region and ranging |
| indicator | | method defined are used for the |
| | | purpose of normal ranging |
| | | 1: The OFDMA region and ranging |
| | | method defined are used for the |
| | | purpose of dedicated CDMA code |
| | | and transmission opportunities |
| System access | 1 | When this bit is set to 1, the |
| restriction indicator | | allocation indicated this |
| (Access restriction | | ranging region shall not be |
| indicator) | | used by M2M devices |

}

As shown in Table 1 and Table 2, the information about the ranging region may be defined according to an OFDMA (orthogonal frequency division multiple access) symbol offset, a subchannel offset, the number of OFDMA symbols, the number of subchannels, and a ranging method. The terminal may check whether the OFDMA symbol offset, the subchannel offset, the number of OFDMA symbols, the number of subchannels, and the ranging method included in the MAP correspond to the OFDMA symbol offset, the subchannel offset, the number of OFDMA symbols, the number of subchannels, and the ranging method allocated through the UCD.

When the information about the ranging region included in the MAP correspond to the information about the raging region allocated through the UCD, the terminal checks the access restriction indicator included in the MAP (S450).

When the access restriction indicator is set to a value (e.g. 0) indicating that access is permitted, the terminal attempts to access the base station through the ranging region designated by the MAP (S460).

Conversely, when the access restriction indicator is set to a value (e.g. 1) indicating that access is not permitted, the terminal does not attempt to access the base station in a corresponding frame (S470).

In this manner, the base station can set the access restriction indicator according to base station load and transmit the access restriction indicator to the terminal through the control channel or control message (e.g. UL-MAP) for resource allocation so as to control access of the terminal at short intervals and manage the base station load.

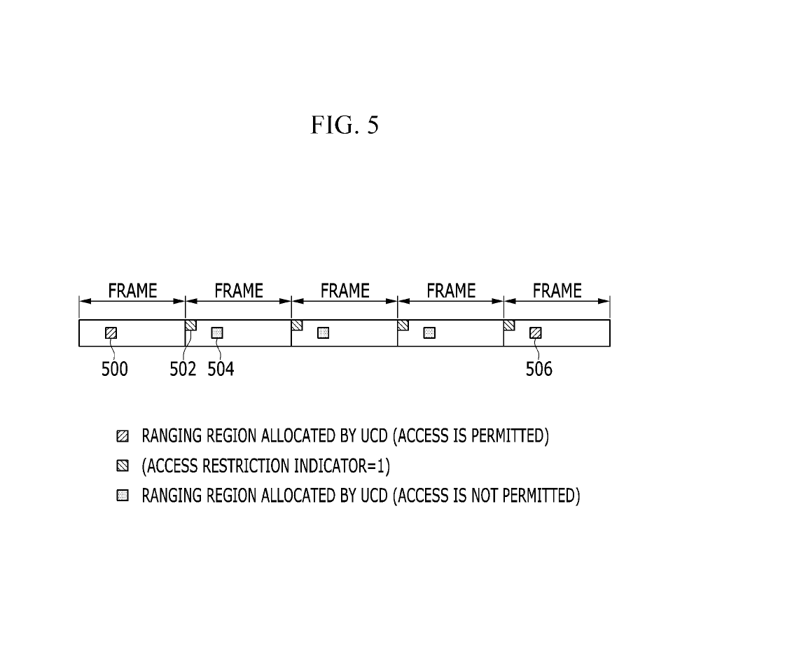

FIG. 5 illustrates a frame structure for load management according to an exemplary embodiment of the present invention.

Referring to FIG. 5, the base station allocates a ranging region 500 through the UCD. After the base station transmits the UCD, if overload is generated before a new UCD is transmitted, the base station transmits a MAP 502 including information about a ranging region allocated by the UCD and an access restriction indicator set to the value (e.g. 1) indicating that access is not permitted to the terminal.

When the MAP includes information about the ranging region that is identical to the ranging region allocated by the UCD and the access restriction indicator is set to 1, the terminal may not attempt to access the base station in a ranging region 504 in a corresponding frame. The base station can block additional access of the terminal by transmitting individual MAPs corresponding to all ranging regions until the overload is cancelled. Accordingly, the terminal in the frame will not attempt to connect to the base station.

When the overload of the base station is cancelled, the base station can permit access of the terminal through a ranging region 506 allocated through the UCD by interrupting transmission of the MAP.

The MAP including the information about the ranging region and the access restriction indicator may be used to additionally allocate a ranging region. For example, the base station can allocate an additional ranging region by transmitting a MAP including information indicating a region other than the ranging region allocated by the UCD and an access restriction indicator set to the value (e.g. 0) representing that access is permitted. Accordingly, it is possible to prevent overload that can be generated when a large number of terminals simultaneously perform initial ranging.

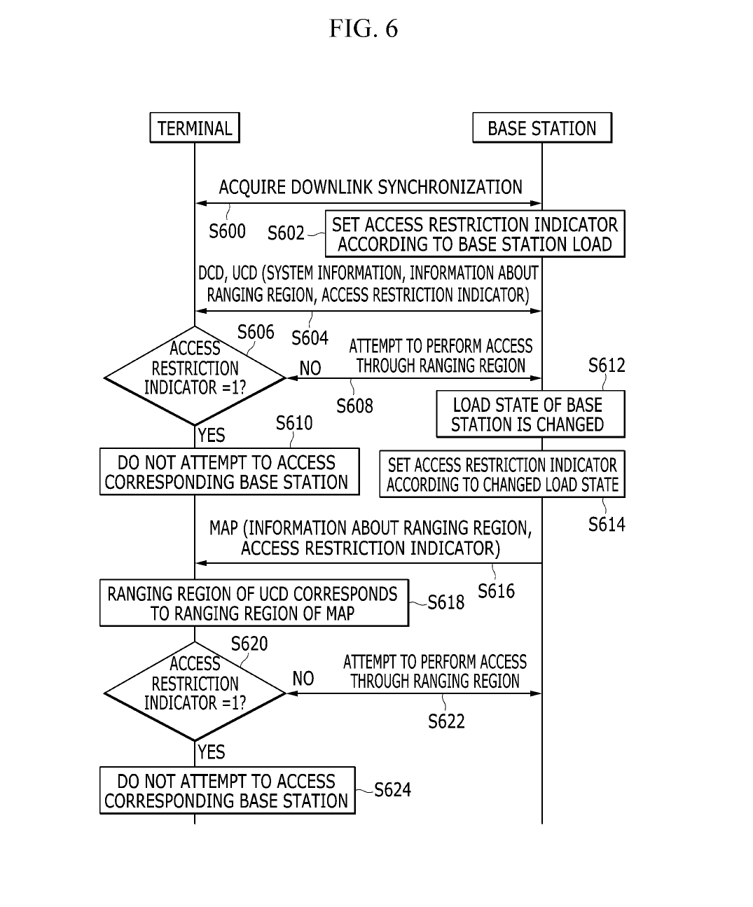

FIG. 6 is a flowchart illustrating a load management method of a base station according to another exemplary embodiment of the present invention.

Referring to FIG. 6, a terminal acquires downlink synchronization with the base station (S600). The base station sets an access restriction indicator according to base station load (S602) and broadcasts/transmits a DCD and a UCD including system information to the terminal (S604). Here, the UCD may include system information necessary for uplink access, information about a ranging region, and the access restriction indicator. For example, when the base station load exceeds a predetermined reference value, the base station can transmit the access restriction indicator set to a value (e.g. 1) indicating that access of the terminal is not permitted. When the base station load is less than the predetermined reference value, the base station can transmit the access restriction indicator set to a value (e.g. 0) indicating that access of the terminal is permitted.

The terminal determines whether or not to attempt to access the base station on the basis of the information about the ranging region and the access restriction indicator included in the UCD (S606). For example, when the access restriction indicator is set to 0, the terminal can attempt to access the base station in the corresponding ranging region (S608). When the access restriction indicator is set to 1, the terminal may not attempt to access the base station in the corresponding ranging region (S610).

After the UCD is transmitted, if the load state of the base station is changed before the base station transmits a new UCD (S612), the base station generates an access restriction indicator according to the changed base station load (S614) and transmits a MAP including information about a ranging region allocated by the UCD and the access restriction indicator to the terminal (S616).

For example, when overload of the base station is cancelled although the access restriction indicator set to the value (e.g. 1) indicating that access of the terminal is not permitted is transmitted in step S604, the base station can transmit a MAP including the information about the ranging region allocated by the UCD and the access restriction indicator set to the value (e.g. 0) representing that access of the terminal is permitted to the terminal.

When overload is generated in the base station while the access restriction indicator set to the value (e.g. 0) indicating that access of the terminal is permitted is transmitted in step S604, the base station may transmit a MAP including the information about the ranging region allocated by the UCD and the access restriction indicator set to the value (e.g. 1) representing that access of the terminal is not permitted to the terminal.

The terminal checks whether the information about the ranging region included in the MAP is identical to the information about the ranging region allocated by the UCD (S618) and checks the access restriction indicator included in the MAP (S620).

When the access restriction indicator is set to the value (e.g. 0) representing that access is permitted, the terminal attempts to access the base station through the ranging region designated by the MAP (S622).

If the access restriction indicator is set to the value (e.g. 1) representing that access is not permitted, the terminal does not attempt to access the base station in the corresponding frame (S624).

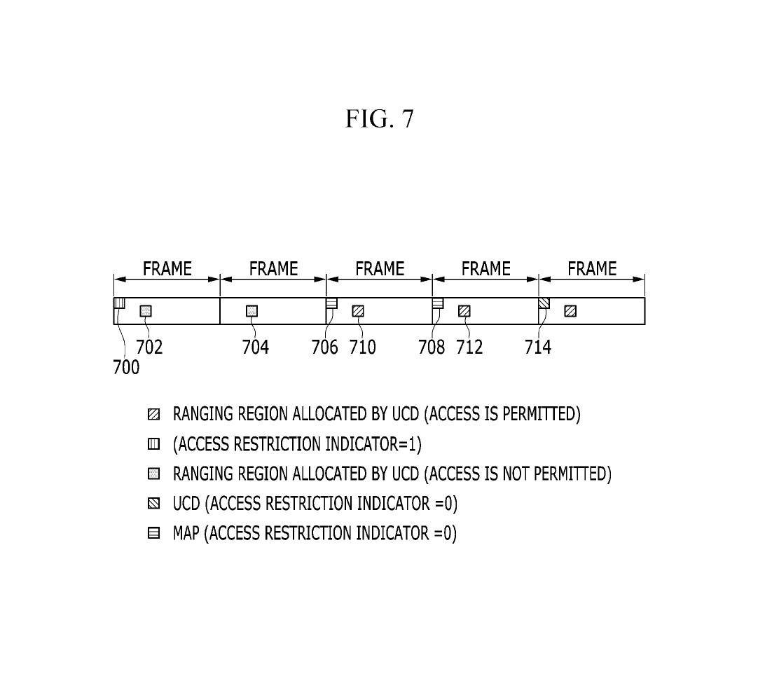

FIG. 7 illustrates a frame structure for load management according to another exemplary embodiment of the present invention.

Referring to FIG. 7, when the base station load exceeds the predetermined reference value, the base station transmits a UCD 700 including information about a ranging region and an access restriction indicator set to a value (e.g. 1) representing that access is not permitted to the terminal.

Upon reception of the UCD, the terminal does not attempt to access the base station through the ranging regions 702 and 704 allocated by the UCD.

When overload of the base station is cancelled, the base station transmits MAPs 706 and 708 including the information about the ranging region allocated by the UCD and the access restriction indicator set to the value (e.g. 0) representing that access is permitted to the terminal.

Upon reception of the MAP, the terminal may attempt to access the base station through ranging regions 710 and 712 allocated by the UCD.

At the UCD transmission timing, the base station may transmit a UCD 714 including information about a ranging region and an access restriction indicator set to the value (e.g. 0) representing that access is permitted to the terminal.

The MAP including the information about the ranging region, and the access restriction indicator may be used to additionally allocate a ranging region. For example, the base station can allocate an additional ranging region by transmitting a MAP including information indicating a region other than the ranging region allocated by the UCD and the access restriction indicator set to the value (e.g. 0) representing that access is permitted.

The load control method according to an exemplary embodiment of the present invention can be applied to a communication environment in which M2M terminals and non-M2M terminals coexist as well as normal communication environments. To achieve this, it is necessary to specify types of terminals which become targets of the access restriction indicator.

There is a method by which the UCD allocates ranging regions by terminal types using an additional parameter. Accordingly, it is possible to interpret the type of a target terminal according to information about a ranging region included in the MAP. For example, when the information about the ranging region included in the MAP corresponds to the information about the ranging region allocated by the UCD to a terminal of type A, it is possible to interpret that the target terminal of the access restriction indicator included in the MAP corresponds to type A.

Another method allocates all ranging regions in the base station through the UCD using one parameter irrespective of terminal type and individually defines a MAP that can be received by each terminal. For example, a MAP can be defined such that MAP-1 can be received by the non-M2M terminal only and MAP-2 can be received by the M2M terminal only.

Another method allocates all ranging regions in the base station through the UCD using one parameter irrespective of terminal type, and includes an identifier indicating terminal type in the MAP. For example, when the identifier included in the MAP is A, it is possible to interpret that the target terminal of the access restriction indicator included in the MAP corresponds to type A.

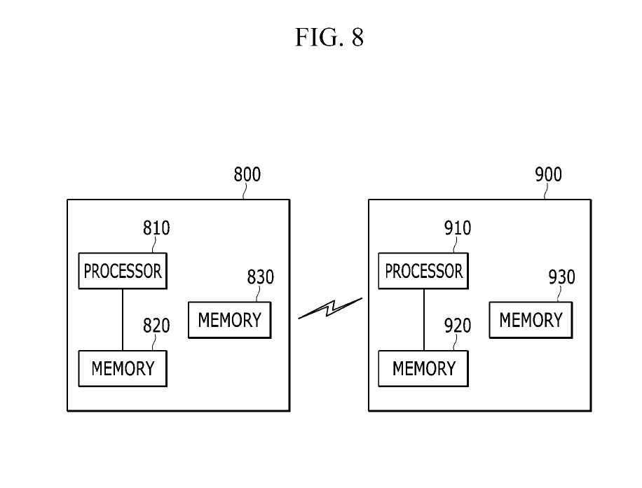

FIG. 8 illustrates a terminal and a base station applicable to exemplary embodiments of the present invention.

Referring to FIG. 8, a mobile communication system includes a terminal 800 and a base station 900. The terminal 800 and the base station 900 respectively include processors 810 and 910, memories 820 and 920, and radio frequency (RF) units 830 and 930. The processors 810 and 910 may be configured to implement the procedures and/or methods proposed by the present invention. The memories 820 and 920 are connected to the processors 810 and 910, and store various types of information relating to operations of the processors 810 and 910. The RF units 830 and 930 are connected to the processors 810 and 910 and transmit and/or receive RF signals. The base station 900 and/or the terminal 800 may include a single antenna or multiple antennas.

According to exemplary embodiments of the present invention, it is possible to efficiently manage base station load by controlling access of a terminal at short intervals. In addition, it is possible to efficiently manage base station load caused by M2M terminals without affecting non-M2M terminals.

The above-described exemplary embodiments of the present invention may be implemented through not only methods and apparatuses but also a program or a recording medium on which the program is recorded, which executes functions corresponding to configurations of the exemplary embodiments of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A system access method of a terminal in a mobile communication system, the method comprising:
receiving a control channel or a control message including resource allocation information, an access restriction indicator, and information about a random access region from a base station; and
determining whether or not to access the base station according to a set value of the access restriction indicator.

2. The system access method of claim 1, wherein the terminal does not access the base station when the access restriction indicator is set to 1 and accesses the base station in the random access region when the access restriction indicator is set to 0.

3. The system access method of claim 1, further comprising receiving a uplink channel descriptor (UCD) including system information necessary for uplink transmission and information about a random access region from the base station.

4. The system access method of claim 3, wherein the random access region allocated by the UCD is identical to the random access region included in the control channel or the control message.

5. The system access method of claim 1, wherein the random access region is defined according to at least one of an OFDMA symbol offset, a subchannel offset, the number of OFDMA symbols, the number of subchannels, and a ranging method.

6. The system access method of claim 1, further comprising receiving a UCD including system information necessary for uplink transmission, an access restriction indicator and information about a random access region from the base station.

7. The system access method of claim 1, wherein the control channel or the control message is a ranging allocation UL-MAP.

8. A method for managing load at a base station in a mobile communication system, the method comprising:
setting an access restriction indicator according to base station load; and
transmitting a control channel or a control message including resource allocation information, the access restriction indicator, and information about a random access region to a terminal.

9. The method of claim 8, wherein the access restriction indicator is set to 0 when access of the terminal is permitted in a frame corresponding to the control channel or the control message, and the access restriction indicator is set to 1 when access of the terminal is not permitted in the frame corresponding to the control channel or the control message.

10. The method of claim 8, further comprising transmitting a UCD including system information necessary for uplink transmission and information about a random access region.

11. The method of claim 10, wherein the UCD further includes an access restriction indicator according to base station load.

12. The method of claim 8, wherein the control channel or the control message is a ranging allocation UL-MAP.

13. A terminal comprising:
a radio frequency (RF) unit; and
a processor,
wherein the processor is configured to receive a control channel or a control message including resource allocation information, an access restriction indicator, and information about a random access region from a base station, and to determine whether or not to access the base station according to a set value of the access restriction indicator.

14. A base station comprising:
an RF unit; and
a processor,
wherein the processor is configured to set an access restriction indicator according to base station load and to transmit a control channel or a control message including the access restriction indicator and information about a random access region.
